(19) United States
(12) Patent Application Publication
(10) Pub. No.: US 2013/0034632 A1
(43) Pub. Date: Feb. 7, 2013

(54) NUTRITIONAL SUPPLEMENTS CONTAINING LIPOIC ACIDS AND SULFUR CONTAINING COMPOUNDS

(71) Applicants: John Cuomo, Salt Lake City, UT (US); Mark J. Brown, Salt Lake City, UT (US); Brian M. Dixon, Salt Lake City, UT (US); Erik Schneider, Bountiful, UT (US)

(72) Inventors: John Cuomo, Salt Lake City, UT (US); Mark J. Brown, Salt Lake City, UT (US); Brian M. Dixon, Salt Lake City, UT (US); Erik Schneider, Bountiful, UT (US)

(21) Appl. No.: 13/196,390

(22) Filed: Aug. 2, 2011

(51) Int. Cl. A23L 1/30

(52) U.S. Cl. 426/96; 426/648; 426/89

(57) ABSTRACT

Nutritional supplements and methods for making and using such supplements are described. In particular, this application describes nutritional supplements with a first part containing an effective amount of a lipoic acid (such as ALA) and a second part containing an effective amount of a sulfur containing compound that increases the level of cellular glutathione (such as NAC). The first and second parts are kept partially or completely separated from each other, thereby minimizing their reaction and maximizing their effectiveness. Such nutritional supplements can be administered to mammals to increase the levels of glutathione while maintaining or increasing the stability of these two components while they are contained in the supplement. Other embodiments are described.

### FIELD

This application relates generally to nutritional supplements. More specifically, this application describes nutritional supplements containing lipoic acids and sulfur containing compounds and methods for maintain or increasing the stability of these two components while in the supplement.

### BACKGROUND

Glutathione is one of the most important antioxidants in the body. As such, maintenance of adequate levels of cellular glutathione in the body is important. Several strategies have been proposed to maintain or increase the levels of cellular glutathione. One strategy includes using nutritional supplements containing Alpha Lipoic Acid (ALA), which is a potent antioxidant. While it is naturally present within cells, particularly in the mitochondria, orally delivered ALA can help increase the concentration in the cells. In addition to having an antioxidant effect in the cells, ALA has been shown to also increase levels of glutathione.

Another strategy to maintain or increase the levels of cellular glutathione includes using nutritional supplements containing cysteine, which is an amino acid and one of the biological building blocks of glutathione. In certain conditions, it can be the rate limiting ingredient need for the biosynthesis of glutathione. Orally delivered forms of cysteine (including N-Acetyl Cysteine (NAC), cysteine hydrochloride, or other salts or derivatives of cysteine) have been shown to increase glutathione and increase detoxification.

### SUMMARY

This application relates to nutritional supplements and methods for making such supplements. In particular, this application describes nutritional supplements with a first part containing an effective amount of a lipoic acid (such as ALA) and a second part containing an effective amount of a sulfur containing compound (such as NAC) that increases the levels of cellular glutathione. The first and second parts are kept partially or completely separated from each other, thereby minimizing their reaction and maximizing their effectiveness. Such nutritional supplements can be administered to mammals while maintaining or increasing the stability of these two components while they are contained in the supplement.

### BRIEF DESCRIPTION OF THE DRAWINGS

The following description can be better understood in light of the Figures, in which:

FIG. 1 shows one chemical formula for alpha lipoic acid; and

FIG. 2 shows one chemical formula for n-acteyl cysteine.

The Figures illustrate specific aspects of the nutritional supplements and methods for making and using such supplements. Together with the following description, the Figures demonstrate and explain the principles of the structures, methods, and principles described herein. In the drawings, the thickness and size of components may be exaggerated or otherwise modified for clarity. The same reference numerals in different drawings represent the same element, and thus their descriptions will not be repeated. Furthermore, well-known structures, materials, or operations are not shown or described in detail to avoid obscuring aspects of the described devices. Moreover, the Figures may show simplified or partial views, and the dimensions of elements in the Figures may be exaggerated or otherwise not in proportion for clarity.

### DETAILED DESCRIPTION

The following description supplies specific details in order to provide a thorough understanding. Nevertheless, the skilled artisan will understand that the nutritional supplements and associated methods of making and using such supplements can be implemented and used without employing these specific details. Indeed, the nutritional supplements and associated methods can be placed into practice by modifying the described supplements and methods and can be used in conjunction with any other apparatus and techniques conventionally used in the industry. For example, while description refers to nutritional supplements and associated methods for administration to a human, it could be modified and used in any mammal. As well, while the description refers to nutritional supplements, the compositions could be administered as dietary supplements or even as medications. In addition, where reference is made to a list of elements (e.g., elements a, b, c), such reference is intended to include any one of the listed elements by itself, any combination of less than all of the listed elements, and/or a combination of all of the listed elements.

Some embodiments of the nutritional supplements and methods for making and using such supplements are described herein and illustrated in the Figures. In these embodiments, the nutritional supplements contain a first part containing an effective amount of a lipoic acid (such as ALA) and a second part containing an effective amount of sulfur containing compounds (such as NAC) that increases the levels of cellular glutathione. The nutritional supplements can be administered to a mammal in need thereof.

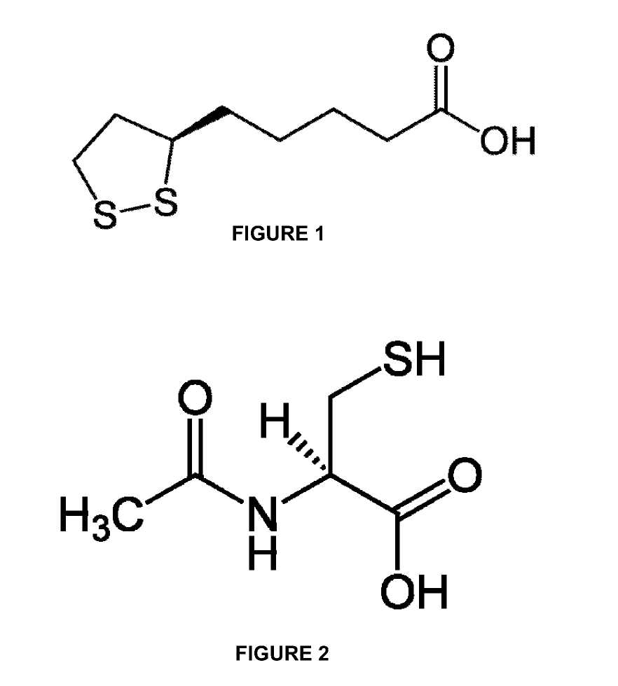

As described above, lipoic acids are known to increase the levels of GSH when orally administered. Accordingly, the nutritional supplements described herein contain lipoic acids. The nutritional supplements can contain any form of lipoic acid. In some embodiments, the lipoic acid can be alpha lipoic acid (ALA), racemic alpha lipoic acid, di-hydro alpha lipoic acid, R-(+) alpha lipoic acid, S-(−) alpha lipoic acid, R-(+) dihydro alpha lipoic acid, S-(−) dihydro alpha lipoic acid, metal salts thereof, esters thereof, or combinations thereof. In other embodiments, the lipoic acid used in the nutritional supplement is alpha lipoic acid (ALA). One chemical formula of ALA is illustrated in FIG. 1.

The lipoic acid (i.e., ALA) can be contained in the nutritional supplemental in any amount that, when combined with the sulfur containing compound, is able to maintain or increase the levels of GSH when it is administered. In some embodiments, the amount of lipoic acid can range up to 50 wt %. In other embodiments, the amount of lipoic acid can range from about 0.5 to about 20 wt %. In even other embodiments, the amount of lipoic acid can range from about 0.5 to about 7 wt %. In still other embodiments, the amount of lipoic acid can be any combination or sub-range of these amounts. With some tablet formulations, the amount of lipoic acid can range from about 5 mg/tablet to about 108 mg/tablet. With other tablet formulations, the amount of lipoic acid can range from about 40 mg/tablet to about 70 mg/tablet. In still other formulations, the amount of lipoic acid can be any combination or sub-range of these amounts.

Depending on the other components in the nutritional supplement, the ALA levels in the NS can also be relatively stable. For example, one liquid nutritional supplement (CoQuinone®) was to made to contain a mixture of ubiquinone and about 12.5 mg of ALA as the active ingredients that were dissolved in an oil base and contained in a gelatin capsule. Samples of this product were manufactured, stored, and the concentration of ALA was measured over time as shown in Table 1.

TABLE 1

| | | | Measured ALA |
|---|---|---|---|
| Lot # | Mfg. Date | Age (days) | mg/tablet |
| 144570 | 10/26 | 720 | 10.3 |
| 145812 | 2/10 | 613 | 11.6 |
| 144571 | 10/25 | 721 | 11.2 |
| 146044 | 1/20 | 634 | 11.2 |
| 147053 | 3/7 | 587 | 11.3 |
| 147890 | 5/12 | 521 | 11.4 |
| 150071 | 8/14 | 427 | 11.8 |
| 151385 | 10/22/ | 358 | 12.1 |
| 152415 | 1/8 | 280 | 11.8 |
| 153107 | 3/9 | 220 | 12.0 |
| 153855 | 4/19 | 179 | 12.4 |

As shown in Table 1, more than about 90% of the ALA remained after 720 days of storage at room temperature.

As well, the nutritional supplements described herein contain any sulfur containing compounds that are able to increase cellular glutathione. In some embodiments, these sulfur containing compounds include cysteine, cystine, n-acteyl cysteine, broccoli or broccoli concentrate (sulforaphane), metal salts thereof, and combinations of these compounds. In some embodiments, these sulfur containing compounds comprise n-acteyl cysteine (NAC). One chemical formula of NAC is illustrated in FIG. 2. NAC is especially useful since it has been shown to well absorbed by the intestine and is readily converted by the cells (particularly in the liver) to glutathione. As well, NAC is especially useful when combined with ALA since ALA is known to mediate induction of GSH and NAC is a building block of GSH; therefore these two ingredients work in concert and perhaps synergistically.

These sulfur containing compounds can be contained in the nutritional supplemental in any amount when combined with the lipoic acid component. In some embodiments, the amount of the sulfur containing compounds can range up to 50 wt %. In other embodiments, the amount of the sulfur containing compounds can range from about 0.5 to about 20 wt %. In even other embodiments, the amount of the sulfur containing compounds can range from about 0.5 to about 7 wt %. In still other embodiments, the amount of the sulfur containing compounds can be any combination or sub-range of these amounts. With some tablet formulations, the amount of the sulfur containing compounds can range from about 60 mg/tablet to about 75 mg/tablet.

Based on their individual abilities to increase GSH levels, a combination of ALA and NAC should also increase cellular glutathione levels. However, these ingredients have not been combined with each other in a single nutritional supplement because they react with each other when they come into contact, thereby becoming destabilized. For example, one nutritional supplement (formulation A) was made to contain about 5 mg ALA and about 25 mg NAC as the main ingredients. Another nutritional supplement (formulation B) was made to contain about 40 mg ALA and 50 mg NAC as the main ingredients. Samples of these products were manufactured, stored, and the concentration of the ALA measured as shown in Tables 2 and 3.

TABLE 2
Formula A

| | | | | Measured ALA |
|---|---|---|---|---|
| Formulation | Bulk Lot # | Mfg. Date | Age (days) | mg/tablet |
| TA103.010002 | 5597 | 10/2 | 744 | 2.3 |
| TA103.010002 | 6068 | 11/15 | 700 | 2.7 |
| TA103.010002 | 6699 | 1/22 | 632 | 3.2 |
| TA103.010002 | 7603 | 4/23 | 540 | 3.6 |
| TA103.010002 | 8319 | 6/10 | 492 | 3.1 |
| TA103.010002 | 9339 | 9/17 | 393 | 3.3 |
| TA103.010002 | 0128 | 12/1 | 318 | 3.8 |
| TA103.010002 | 0439 | 1/12 | 276 | 4.2 |
| TA103.010003 | 1440 | 3/11 | 218 | 3.9 |
| TA103.010002 | 2069 | 5/19 | 149 | 4.2 |
| TA103.010002 | 2230 | 6/2 | 135 | 4.2 |
| TA103.010003 | 2642 | 7/16 | 91 | 4.6 |

Formula B

| | | | | Measured ALA |
|---|---|---|---|---|
| Formulation | Bulk Lot # | Mfg. Date | Age (days) | mg/tablet |
| TA135.010001 | 5694 | 10/10 | 736 | 26.8 |
| TA135.010001 | 6207 | 11/29 | 686 | 26.8 |
| TA135.010001 | 6626 | 1/9 | 645 | 25.2 |
| TA135.010001 | 7047 | 2/18 | 605 | 29.6 |
| TA135.010001 | 7492 | 4/4 | 559 | 28 |
| TA135.010001 | 7994 | 5/13 | 520 | 29 |
| TA135.010001 | 8963 | 8/21 | 420 | 27.2 |
| TA135.010001 | 9860 | 10/20 | 360 | 30.6 |
| TA135.010001 | 0965 | 2/11 | 246 | 34 |
| TA135.010001 | 1696 | 4/16 | 182 | 30.4 |
| TA135.010001 | 2086 | 5/21 | 147 | 34.4 |

As seen in Tables 2 and 3, the ALA concentration in both of these nutritional supplements decreased by up to about 50% because of the presence of NAC. It is believed that this decrease occurs because NAC reacts with ALA.

With the NS described herein, however, these two ingredients (ALA and NAC) can be combined into a single delivery vehicle that limits the contact between the two ingredients. In this configuration, high levels of both of these ingredients can be delivered (and maintained) in a single oral dosage, increasing the levels of glutathione and providing a detoxification system without the ALA and NAC becoming destabilized.

To limit their contact, these two ingredients can be combined in various different forms. In some embodiments, the form comprises separate tablets, separate capsules, or separate powders that can be administered at the same time. The ALA is kept in one of the tablets, capsules, or powders while the NAC is kept in the other. The ingredients only contact each other as they are administrated in the body.

In other embodiments, these two ingredients can be combined in the form of a single tablet or capsule. In these embodiments, the ALA ingredient is contained with a first part of the tablet or capsule and the NAC ingredient is contained in a second part of the tablet or capsule. The first part and the second part are kept partially or completely separated from each other using any known separation technique. In some embodiments, this separation technique includes forming the first part as a homogenous first layer in the tablet and the second part as a homogenous second layer in the tablet. The contact between the ALA ingredient in the first layer and the NAC ingredient in the second layer is minimized since they only contact each other only at the interface between the first and second layers.

For example, in some configurations, a typical tablet shape comprises a caplet which has about the shape of a rectangular box. A bi-layer tablet in these configurations comprises two of these boxes sandwiched together. The amount of material required to coat the entire tablet can range from about 1 to about 5% of the mass of the entire tablet. So the amount of contact of the two layers can be approximated by taking half of the coating mass needed for just one face of a rectangular box. Thus, the amount of ALA from one layer in contact with the NAC in the other layer can be approximated to range between about 0.5% and about 2.5%, assuming the ingredients are distributed uniformly throughout the respective layers of the tablet.

In other embodiments, this separation technique includes forming the first part as a first layer in the tablet and the second part as a second layer in the tablet. Both the first and second layers are given a concentration gradient where the active component (i.e., the ALA or NAC) in the tablet is maximized at exterior of the tablet and minimized at the location where the two layers contact each other. In these embodiments, the contact between the ALA ingredient in the first layer and the NAC ingredient in the second layer is minimized since they only contact each other only at the interface between the first and second layers where the concentration of these two components at that interface has been minimized.

In other embodiments, this separation technique includes forming the first part as a first layer in the tablet and the second part as a second layer in the tablet. In these embodiments, the contact between the ALA ingredient in the first layer and the NAC ingredient in the second layer is reduced by providing a barrier between the two layers. In some configurations, the barrier can comprise a physical barrier, such as a film of the same material as the capsule that dissolves on contacting saliva. The physical barrier can have any thickness sufficient to prevent any contact between the two layers. In other configurations, the physical barrier can comprise a chemical component that prevents these two ingredients from reacting with each other. Examples of such chemical components include magnesium carbonate, potassium carbonate and sodium carbonate.

In other embodiments, these two ingredients can be combined in the form of a single powder. A first portion of the powder can contain the ALA ingredient and the second portion can contain the NAC ingredient. While the first and second portions can be mixed, the contact between the two ingredients can be minimized or eliminated by coating the first and/or second portions with a non-reactive layer having a thickness sufficient to prevent any substantial contact and/or reaction between the two ingredients. Examples of non-reactive layers for the ALA include combinations of cellulose and food grade wax. In one formulation, the ALA used was coated with a cellulose and food grade wax when incorporated into the nutritional supplement.

In another form, these two ingredients can be combined in a capsule as separated liquids. In this form, the nutritional supplement contains a first, inner capsule containing one of these two ingredients in liquid form. The first capsule is completely contained within a second, outer capsule that contains the other ingredient in liquid form. Thus, the two liquids are kept separated from each other by the wall of the inner capsule.

The actual amount of contact between these two ingredients will depend on the form in which the two ingredients are contained in the nutritional supplement. In some embodiments, the contact between these two ingredients can be substantially eliminated. In other embodiments, the contact between the two ingredients can be minimized to less than about 3%. In other embodiments, the contact between the two ingredients can be minimized to about 3% to about 20%.

With such limited contact, any reaction between the ingredients can also be eliminated or reduced. In some embodiments, the reaction between these two ingredients can be substantially eliminated. In other embodiments, the reaction between the two ingredients can be minimized to less than about 10%. In other embodiments, the reaction between the two ingredients can be minimized to less than about 20%.

In some embodiments, the ALA and NAC work synergistically to provide the necessary nutrients required for glutathione production while supporting the body's ability to produce and preserve existing stores of GSH. The effect of these two ingredients together is far more significant than using ALA or NAC alone.

Besides the lipoic acid and these sulfur containing compounds, the NS can also contain any other known dietary or nutritional compounds that can be added to either (or both) parts of the NS. These dietary or nutritional compounds include vitamins. Examples of the vitamins include B-complex vitamins like choline bitartate, biotin, and combinations thereof; vitamin-C compounds; vitamin D compounds; and combinations thereof. The amount of the vitamins in the nutritional supplement can range up to about 50 wt %.

Other known dietary or nutritional compounds include carbohydrates. Examples of the carbohydrates include inositol. The amount of the carbohydrates in the nutritional supplement can range up to about 50 wt %.

Other known dietary or nutritional compounds include antitoxins. Examples of the antitoxins include milk thistle extract (Silimarin 80%). The amount of the antitoxins in the nutritional supplement can range up to about 50 wt %.

Other known dietary or nutritional compounds include antioxidants (other than ALA and NAC). Examples of the other antioxidants include green tea extract, olive leaf extract, meriva turmeric phytosome (curcuminoids), or combinations thereof. The concentration of the additional anti-oxidants would be any effective amount which would work with ALA and the NAC ingredient. Accordingly, the amount of the antioxidants in the nutritional supplement can range up to about 50 wt %.

The NS can also contain other additives, such binders, disintegrants, lubricants, flowing agents, flavorings, coatings, and combinations of these additives that can be added to either (or both) parts of the NS. Examples of the binders that can be used in the NS include microcrystalline cellulose, modified cellulose (Klucel), pre-gelatinized starch, or combinations thereof. Examples of the disintegrants that can be used include croscarmellose sodium. Examples of the lubricants that can be used include ascorbyl palmitate, vegetable fatty acid, or combinations thereof. Examples of the flowing agents that can be used include silicon dioxide. Examples of the flavorings include vanilla extract. The concentration of these additives in the NS can range from about 1 to about 99 wt %.

The NS can be prepared in various forms, including tablets, capsules, and powders. Solid diluents or carriers for the solid forms can be lipids, carbohydrates, proteins, mineral solids (e.g., starch, sucrose, kaolin, dicalcium phosphate, gelatin, acacia, corn syrup, corn starch, talc, and their combinations), and combinations thereof. Capsules can be formulated with known diluents and excipients, for example, edible oils, talc, calcium carbonate, calcium stearate, magnesium stearate, and combinations thereof. Liquid preparations for oral administration may be prepared in water or aqueous solutions which advantageously contain suspending agents, such as for example, sodium carboxymethylcellulose, methylcellulose, acacia, polyvinyl pyrrolidone, polyvinyl alcohol and combinations thereof. Such preparations must be stable under the conditions of manufacture and storage, and ordinarily contain in addition to the basic solvent or suspending liquid, preservatives in the nature of bactericidal and fungicidal agents, for example, parabens, chlorobutanol, benzyl alcohol, phenol, thimerosal, and the like. In many cases it is preferable to include isotonic agents, for example, sugars or sodium chloride. Carriers and vehicles include vegetable oils, water, ethanol, and polyols, for example, glycerol, propylene glycol, liquid polyethylene glycol, and the like.

The NS can be prepared using any known method that will manufacture the desired form with the components in the desired concentrations. In some embodiments, the ingredients for part (or side) A are first weighed out and then transferred to a blender. After the ingredients for part A have been mixed in the blender, they are transferred to a hopper that feeds a tablet press. The same process is repeated for the ingredients contained in part (or side) B of the tablet. The ingredients for side B can then be transferred to a different hopper that feeds the tablet press. The side A mixture is fed into the press and lightly compressed followed by addition of the side B mixture and a final compression to form the tablet. The compressed tablets are then transferred to a coating pan where the coating solution is applied and the tablets are dried.

The Examples below illustrate the NS and methods of making them.

### Example 1

Several packaged tablets were manufactured to contain the components shown in Table 4. The tablets were made by first weighing the individual ingredients and combining them into blender. After blending to a uniform mixture, a conventional tablet press was used to produce the respective tablets. After coating, the tablets were packaged in a sealed plastic bottle and stored under various conditions. Some of the tablets were made with sulfur-containing compounds such as N-acetyl L-cysteine (NAC) and broccoli (sulforaphane) and some were made without these sulfur-containing compounds.

TABLE 4

| Ingredient | AV1042 | AV1055* | AV1069 | AV1074 | AV1075 | AV1111 |
|---|---|---|---|---|---|---|
| Milk Thistle Extract, Silimarin 80% | | YES | | | | |
| Green Tea Extract (Decaff) | | YES | | YES | | |
| Olive Extract | | YES | | YES | | |
| Turmeric Extract | | YES | | YES | | |
| Broccoli concentrate | | YES | | | | |
| Lipoic acid | 108 Mg | 40 Mg | 108 Mg | 40 mg | 40 mg | 40 mg |
| N-acetyl L-cysteine | | YES | | | YES | |
| Betaine | | YES | | | | |
| Choline | | | | | | YES |
| Grape Seed Extract | YES | | | | | |
| Resveratrol | YES | | | | | |
| Microcrystalline Cellulose | YES | YES | YES | YES | YES | YES |
| Ascorbyl Palmitate | YES | YES | YES | YES | YES | YES |
| Crosscarmelose Sodium | YES | YES | YES | YES | YES | YES |
| Silicon Dioxide | YES | YES | YES | YES | YES | YES |

*The lipoic acid used in AV1055 was coated with cellulose and food grade wax.

Some accelerated stability studies were performed at about 40° C. and about 75% humidity to measure the ALA content using HPLC (high performance liquid chromatography) on the formulations listed in Table 4 over an 8 week period. It was determined that NAC and the broccoli extract have a negative impact on the shelf life of a tablet containing ALA since AV1074 (which did not contained NAC) retains a higher amount of ALA than AV1075 (which contained NAC) after 8 weeks in accelerated storage, as shown in Table 5.

TABLE 5

| Formulation | Initial | 2 weeks | 4 weeks | 6 weeks | 8 weeks |
|---|---|---|---|---|---|
| AV1042 | 105 | 99 | 98 | 97 | |
| AV1055 | 50.0 | 42.0 | 38.0 | 37.8 | 30.5 |
| AV1069 | 107 | 107 | 108 | 107 | |
| AV1074 | 39.0 | 39.8 | 39.6 | 34.9 | 39.0 |
| AV1075 | 39.0 | 30.5 | 26.9 | 26.7 | 21.0 |
| AV1111 | 38.4 | 39.2 | 34.9 | 34.6 | 39.1 |

### Example 2

To create a more stable tablet that contained both ALA and NAC, a bi-layer tablet (AV1101) was made that separated these two ingredients into two separate layers of the tablet, as shown in Table 6. This tablet was produced by first weighing and mixing the components of side A and then weighing and mixing the components of side B. Each mixture was individually loaded into the respective hoppers of a bi-layer tablet press. The bilayer tablet was produced by first compressing layer A, then loading mixture B on top of the partially compressed tablet, and finally compressing the two layers together. The final product was coated and packaged in a sealed plastic bottle for storage.

TABLE 6
Tablet AV1101

| Ingredient | Side A (AV1092) | Side B (AV1089) |
|---|---|---|
| Milk Thistle Extract, | | YES |
| Silimarin 80% | | |
| Green Tea Extract (Decaff) | | YES |
| Olive Extract | | YES |
| Turmeric Extract | | YES |
| Broccoli concentrate | | 25 mg |
| Lipoic acid | 40 mg | |
| N-acetyl L-cysteine | | 50 mg |
| Choline | | YES |
| Grape Seed Extract | | |
| Resveratrol | | |
| Microcrystalline Cellulose | YES | YES |
| Ascorbyl Palmitate | YES | YES |
| Crosscarmelose Sodium | YES | YES |
| Silicon Dioxide | YES | YES |

As shown in Table 7, this tablet was more stable under the accelerated storage conditions when compared to the formulations listed in Table 5.

TABLE 7

| Formulation | Initial | 2 weeks | 4 weeks | 6 weeks | 8 weeks |
|---|---|---|---|---|---|
| AV1101 | 31.0 | 27.8 | 29.9 | 29.0 | 28.9 |

### Example 3

An additional sample of the NS was manufactured and tested. This sample contained NAC and ALA in a bilayer tablet with the formulation shown in Table 8. The bilayer tablet was produced as in Example 2. The sample was tested by HPLC and the stability data for the sample is reported in Table 9.

TABLE 8

| | Active Ingredient | |
|---|---|---|
| Nutrient/ingredient | mg/tab | mg/tab |
| Broccoli concentrate (Sulforiphane) | 25 | 25.000 |
| L-Cystine | 55 | 55.838 |
| Choline bitartrate | 62.5 | 66.489 |
| Biotin | 0.075 | 8.250 |
| Inositol | 25 | 25.770 |
| Milk Thistle Extract, Silimarin 80% | 80 | 84.000 |
| Green Tea Extract (Decaff) | 15 | 15.750 |
| Olive Extract | 15 | 15.000 |
| Meriva-Turmeric phytosome (Curcuminoids) | 1.5 | 7.500 |
| Microcrystalline cellulose | — | 111.181 |
| Klucel (modified cellulose) | — | 20.000 |
| Pregelatinized starch | — | 15.000 |
| Croscarmellose sodium | — | 20.000 |
| Ascorbyl palmitate | — | 16.000 |
| Vegetable Fatty Acid | — | 22.000 |
| Silicon Dioxide | — | 30.000 |
| Sup Part A | | 537.778 |
| alpha-lipoic acid | 67 | 87.450 |
| Choline bitartrate | 62.5 | 66.489 |
| Microcrystalline cellulose | — | 145.283 |
| Pregelatinized starch | — | 45.000 |
| Vegetable Fatty Acid | — | 11.000 |
| Ascorbyl palmitate | — | 17.000 |
| Silicon Dioxide | — | 30.000 |
| Sub part B | | 402.222 |
| Clear film coating | — | 9.400 |
| Vanilla Extract | | 1.440 |
| Total A&B | | 949.400 |

TABLE 9

| | | | | Results | Results | Results |
|---|---|---|---|---|---|---|
| | Test | | | 0 | 3 | 6 |
| Test | Method | Specification | Unit | Month | Months | Months |
| Alpha Lipoic Acid | 23.116 | 90-120% label claim | % of | 119 | 118 | 110 |
| | | (67.000 mg) | Label | | | |
| Choline Bitartrate | 23.142 | 90-150% label claim | % of | 95 | 104 | 95 |
| | | (125.000 mg) | Label | | | |
| L-Cystine | 23.097 | 90-120% label claim | % of | 102 | 91 | 103 |
| | | (55 mg) | Label | | | |
| Biotin | 23.098 | 90-150% label claim | % of | 105 | 109 | 118 |
| | | (75.00 μg) | Label | | | |
| Inositol | 23.168 | 90-120% label claim | % of | 108 | 109 | 101 |
| | | (25.00 mg) | Label | | | |
| Total Aerobic | 23.508 | ≦3,000 | CFU/ | <10 | NT | NT |
| Microbial Count | | | g | | | |

### Example 4

Two samples of another formulation were manufactured and tested. This formulation contained L-cystine and ALA in a bilayer tablet with the formulation shown in Table 10. The bilayer tablets were produced as described in Example 2. The samples were tested by HPLC and the stability data for the samples are reported in Tables 11 and 12, respectively.

TABLE 10

| | Active Ingredient | |
|---|---|---|
| Nutrient/ingredient | mg/tab | mg/tab |
| Broccoli concentrate (Sulforiphane) | 25 | 25.000 |
| N-acetyl L-cysteine | 75 | 78.750 |
| Choline bitartrate | 62.5 | 66.489 |
| Biotin | 0.075 | 8.250 |
| Milk Thistle Extract, Silimarin 80% | 80 | 84.000 |
| Green Tea Extract (Decaff) | 15 | 15.750 |
| Olive Extract | 15 | 15.000 |
| Turmeric Extract | 15 | 15.000 |
| Microcrystalline cellulose | — | 111.038 |
| Klucel (modified cellulose) | — | 20.000 |
| Pregelatinized starch | — | 15.000 |
| Croscarmellose sodium | — | 20.000 |
| Ascorbyl palmitate | — | 38.000 |
| Silicon Dioxide | — | 30.000 |
| Sup Part A | | 542.277 |
| alpha-lipoic acid | 67 | 87.450 |
| Choline bitartrate | 62.5 | 66.489 |
| Microcrystalline cellulose | — | 150.783 |
| Pregelatinized starch | — | 45.000 |
| Ascorbyl palmitate | — | 28.000 |
| Silicon Dioxide | — | 30.000 |
| Sub part B | | 407.72 |
| Clear film coating | — | 9.500 |
| Vanilla Extract | | 1.440 |
| Total A&B | | 959.500 |

TABLE 11

| | | | | Results | Results | Results |
|---|---|---|---|---|---|---|
| | Test | | | 0 | 3 | 6 |
| Test | Method | Specification | Unit | Month | Months | Months |
| Alpha Lipoic Acid | 23.116 | 80-120% label claim | % of | 119 | 117 | 107 |
| | | (67.000 mg) | Label | | | |
| Choline Bitartrate | 23.142 | 90-150% label claim | % of | 100 | 105 | 94 |
| | | (125.000 mg) | Label | | | |
| N-Acetyl-L- | 23.097 | 90-120% label claim | % of | QBI | 91 | 109 |
| Cysteine | | (75 mg) | Label | | | |

TABLE 12

| | | | | Results | Results | Results |
|---|---|---|---|---|---|---|
| | Test | | | 0 | 3 | 6 |
| Test | Method | Specification | Unit | Month | Months | Months |
| Alpha Lipoic Acid | 23.116 | 80-120% label claim | % of | 106 | 112 | 110 |
| | | (67.000 mg) | Label | | | |
| Choline Bitartrate | 23.142 | 90-150% label claim | % of | 103 | 97 | 91 |
| | | (125.000 mg) | Label | | | |
| N-Acetyl-L- | 23.097 | 90-120% label claim | % of | QBI | 91 | 97 |
| Cysteine | | (75 mg) | Label | | | |

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. A nutritional supplement, comprising:
a first part containing an effective amount of a lipoic acid; and
a second part containing an effective amount of a sulfur containing compound that increases the level of cellular glutathione;
wherein the first part and second part are partially or completely separated.

2. The supplement of claim 1, wherein the first part and second part are separated by a physical barrier.

3. The supplement of claim 2, wherein the physical barrier contains a non-reactive chemical component.

4. The supplement of claim 1, wherein the first and second part are powders separated using a non-reactive coating on one or both of the powders.

5. The supplement of claim 1, wherein the first part and second part are liquids separated by a capsule.

6. The supplement of claim 1, wherein the nutritional supplement is in the form of a tablet or capsule with the first part forming a first layer and the second part forming a second layer.

7. The supplement of claim 1, wherein the lipoic acid comprises alpha lipoic acid (ALA), racemic alpha lipoic acid, di-hydro alpha lipoic acid, R-(+) alpha lipoic acid, S-(−) alpha lipoic acid, R-(+) dihydro alpha lipoic acid, S-(−) dihydro alpha lipoic acid, metal salts thereof, esters thereof, or combinations thereof.

8. The supplement of claim 1, wherein the lipoic acid comprises alpha lipoic acid.

9. The supplement of claim 1, wherein the sulfur containing compounds comprise cysteine, cystine, n-acteyl cysteine, sulforaphane, metal salts thereof, or combinations thereof.

10. The supplement of claim 1, wherein the sulfur containing compounds comprise n-acteyl cysteine.

11. A nutritional supplement tablet, comprising:
a first layer containing an effective amount of alpha lipoic acid; and
a second layer containing an effective amount of n-acteyl cysteine;
wherein the first part and second layers are partially or completely separated.

12. The tablet of claim 11, wherein the first and second layers are separated by a physical barrier.

13. The tablet of claim 12, wherein the physical barrier contains a non-reactive chemical component.

14. The tablet of claim 11, wherein the first and second layers contact each other at an interface between the layers.

15. The tablet of claim 14, wherein the contact between the layers ranges from about 0.5% to about 2.5% of the mass of the tablet.

16. The tablet of claim 11, wherein the reaction between the alpha lipoic acid and the n-acteyl cysteine can be limited to less than 20%.

17. A method of making a nutritional supplement, comprising:
providing a first part containing an effective amount of lipoic acid;
providing a second part containing an effective amount of sulfur containing compound that increases the level of cellular glutathione; and
combining the first part and the second part in a single delivery vehicle while keeping the first part and second parts partially or completely separated.

18. The method of claim 27, wherein the lipoic acid comprises alpha lipoic acid.

19. The method of claim 17, wherein the sulfur containing compounds comprise n-acteyl cysteine.

20. A nutritional system, comprising:
a first nutritional supplement; and
a second nutritional supplement, comprising:
a first part containing an effective amount of a lipoic acid; and
a second part containing an effective amount of a sulfur containing compound that increases the level of cellular glutathione;
wherein the first part and second part are partially or completely separated.

21. The system of claim 20, wherein the first part and second part are separated by a physical barrier.

22. The system of claim 20, wherein the lipoic acid comprises alpha lipoic acid.

23. The system of claim 20, wherein the sulfur containing compound comprise n-acteyl cysteine.

24. A nutritional system, comprising:
a first nutritional supplement containing an effective amount of a lipoic acid; and
a second nutritional supplement containing an effective amount of a sulfur containing compound that increases the level of cellular glutathione;
wherein the first nutritional supplement and the second nutritional supplement are completely separated from each other.

25. The system of claim 24, wherein the lipoic acid comprises alpha lipoic acid and the sulfur containing compound comprises n-acteyl cysteine.
